(19) United States
(12) Patent Application Publication
(10) Pub. No.: US 2026/0295905 A1
(43) Pub. Date: Oct. 1, 2026

(54) INJECTION MOLD SYSTEM, METHOD AND ARTICLE

(71) Applicant: IMPOSSIBLE OBJECTS, INC., Northbrook, IL (US)

(72) Inventors: Robert D. Swartz, Highland Park, IL (US); Eugene Gore, Wilmette, IL (US); Christopher Wagner, Northbrook, IL (US); Shay Wallace, Highland Park, IL (US)

(73) Assignee: IMPOSSIBLE OBJECTS, INC., Northbrook, IL (US)

(21) Appl. No.: 19/247,970

(22) Filed: Jun. 24, 2025

Related U.S. Application Data
(60) Provisional application No. 63/663,411, filed on Jun. 24, 2024.

(51) Int. Cl. B29C 33/38; B29C 33/40; B29C 45/26; B33Y 80/00

(52) U.S. Cl. CPC B29C 33/3842; B29C 33/3807; B29C 33/40; B29C 45/26; B33Y 80/00; B29K 2871/00; B29K 2907/04; B29K 2909/04; B29K 2909/08

(57) ABSTRACT

An improved injection mold system, method, and article are disclosed, utilizing composite-based additive manufacturing (CBAM) techniques. Carbon fiber and fiberglass substrates combined with polymers, such as PEEK, produce durable molds with reduced flexing, enhanced thermal conductivity, and compatibility with higher melting point resins. The addition of boron nitride powder improves cycle times, part release, and surface finish. Molds can be fabricated rapidly at lower costs, supporting short runs, prototyping, and iterative design testing, while maintaining high-quality standards and extended mold life.

### CROSS REFERENCE TO RELATED APPLICATION

This application claims the benefit of priority of U.S. provisional application No. 63/663,411, filed Jun. 24, 2024, the contents of which are herein incorporated by reference.

### BACKGROUND OF THE INVENTION

Injection molding is a well-established manufacturing process that has facilitated the production of a wide range of parts used in numerous applications. Over time, this process has been refined to achieve high-volume production with relatively low per-unit costs. Traditional mold-making techniques have evolved over decades and are widely recognized for their reliability. Nonetheless, these techniques often involve substantial design efforts, complex machining, and considerable investment in specialized tooling, which can reduce adaptability and responsiveness in modern manufacturing settings.

In various industries—from consumer goods to automotive components—efficient production is a primary objective. Manufacturers aim to achieve rapid turnaround times and reduced production costs while maintaining the quality and durability of molded parts. This goal motivates the exploration of methods that accelerate mold fabrication while adhering to the stringent standards required by modern applications. Initiatives to optimize the creation of molds focus on minimizing downtime and facilitating the transition from design to production. These efforts become particularly relevant in scenarios involving small production runs or rapid prototyping, where conventional methods may face challenges in adapting swiftly to changing design and production requirements.

Despite the advancements in mold-making practices, significant challenges persist. Established fabrication methods can be resource intensive and sometimes unpredictable, leading to delays and heightened costs. Issues of importance include extended lead times for designing and fabricating molds, as well as the risk of initial setups not performing as anticipated. This can result in repeated adjustments, maintenance challenges, and overall inefficiencies in production operations. The need to ensure that molds maintain their dimensional stability, thermal performance, and consistent quality over time remains a pressing concern across multiple manufacturing sectors.

More specifically, the process of developing molds that reliably meet the strict operational parameters demanded by high-performance injection molding remains challenging. Manufacturers often encounter difficulties when attempting to balance the competing requirements of rapid production, cost-effectiveness, and long-term mold durability. For instance, issues related to mold flexing, thermal inefficiencies, and the complexities associated with mold repair can culminate in production bottlenecks. These persistent issues highlight the importance of exploring alternative approaches to mold fabrication that can provide improved consistency, reduced cycle times, and lower overall costs while addressing the limitations imposed by conventional fabrication techniques.

As mentioned, parts of the injection molding process are time-consuming and expensive. However, it has the advantage of mass-producing parts relatively quickly at low cost. Molding making is expensive, where molds can take months or even years to produce and can cost hundreds of thousands of dollars and require skilled engineers to design and make. Mold design is difficult and unpredictable and often when a mold is first put into a press, it does not work properly and has to be reworked. Beyond that, molds often break and require costly and time-consuming repair, which disrupts production and schedules.

What is needed is a cheaper, faster and changeable mold-creation process, and molds that result from it. Take for example a mission-critical mold, of which a company has made only a single mold to handle all hits. It is a common story that such mission-critical molds break at inconvenient times, with no recourse to the manufacturer, resulting in bottlenecks. If molds were cheap, it would be a simple matter to plan for a second mold on-site that can identically make the necessary part. Alternatively, if design changes are needed, it would be advantageous to have a quick production run available to make the next mold evolution containing an design change.

There has also been a long felt need to speed up the production of molds and reduce the cost. This is especially true for short runs and new product introduction. One of the popular methods (among many) is one made by Protolabs that does short run injection molding by using CNC machines to make aluminum tools. Even this process can take weeks to months and is costly. There are now a number of 3D printing methods for making primarily metal tools which have different advantages and disadvantages. There is a long felt need to speed up the process of making tools and at lower the costs.

Additive manufacturing techniques have also been used including stereolithography and selective laser sintering, among others, to make injection molding tools. These methods have a number of problems including short mold life, low draft angles, and flexure of the mold, making part release more difficult, not to mention low melting point mold materials.

### SUMMARY OF THE INVENTION

The present invention provides a mold fabrication system that reduces production time from weeks to hours, lowers costs, and enables rapid prototyping and backup molds, and short production runs.

In one embodiment, the present invention includes an injection mold manufactured from layers of a composite material to form a mold structure. The composite material comprises a high performance polymer and boron nitride powder—where the boron nitride powder may be hexagonal and is present in an amount ranging from about 10 wt % to about 20 wt % to enhance thermal conductivity and reduce flexing—as well as either carbon fiber or fiberglass. Mold construction without boron nitride is also possible and yields acceptable results.

In another embodiment, the present invention includes a method for fabricating an injection mold comprising blending a high performance polymer with boron nitride powder to form a composite powder, wherein the boron nitride powder is present in an effective amount to increase thermal conductivity and reduce flexing, and where this combination powder is use as an input to a CBAM process. The method further comprises incorporating a substrate for the CBAM process that uses reinforcing fibers chosen from carbon fiber and fiberglass or other substrates. The method optionally includes applying a surface finishing treatment by techniques such as electroless plating, electroplating, or continuous vapor deposition, and employing the mold structure in an injection molding apparatus to produce injection molded parts with improved cycle times, superior surface finish, and enhanced durability. In some embodiments, the high performance polymer may be polyether ether ketone (PEEK).

In yet another embodiment, the disclosure includes a composite injection mold comprising a mold body that defines at least one mold cavity and core for shaping an injection molded part. The mold body is formed from a composite material that includes a high performance polymer, boron nitride powder—present in an amount effective to enhance thermal conductivity and reduce flexing—and may also include reinforcing fibers selected from carbon fiber and fiberglass. Furthermore, a surface finishing coating is optionally disposed on an exterior surface of the mold body to increase surface hardness and enhance the overall finish. The composite injection mold is adapted for use in an injection molding apparatus to produce parts exhibiting improved cycle times, reduced mold deformation, and increased durability.

These and other features, aspects and advantages of the present invention will become better understood with reference to the following drawings, description and claims.

### BRIEF DESCRIPTION OF THE DRAWINGS

The accompanying drawing figures show exemplary injection molds made according to the teachings of this disclosure.

FIG. 1 illustrates a mechanical drawing of a mold cavity and core within an injection mold system in accordance with a preferred embodiment of the present invention.

FIG. 2 is a perspective view illustrating three mold components of an injection mold structure in accordance with a preferred embodiment of the present invention.

FIG. 3 is a mechanical drawing illustrating an injection mold fabrication system incorporating a composite-based additive manufacturing mold in accordance with a preferred embodiment of the present invention.

FIG. 4 illustrates a mechanical drawing of top and bottom mold cavity and core configurations for shaping injection molded parts in accordance with a preferred embodiment of the present invention.

FIG. 5 illustrates a perspective view of a mold structure fabricated using the composite-based additive manufacturing process in accordance with a preferred embodiment of the present invention.

FIG. 6 illustrates an alternative perspective view of the mold structure of FIG. 5.

FIG. 7 provides a front elevation view of the mold structure of FIG. 5 annotated dimensions A and B for reference.

FIG. 8 shows a side elevation view of the mold structure of FIG. 5 highlighting the thickness C and profile of the mold.

FIG. 9 illustrates a perspective view of a mold structure fabricated using the composite-based additive manufacturing process in accordance with a preferred embodiment of the present invention.

FIG. 10 illustrates an alternative perspective view of the mold structure of FIG. 9.

FIG. 11 provides a front elevation view of the mold structure of FIG. 9 annotated dimensions D and E for reference.

FIG. 12 shows a side elevation view of the mold structure of FIG. 9 highlighting the thickness F and profile of the mold.

FIG. 13 illustrates a perspective view of a mold structure fabricated using the composite-based additive manufacturing process in accordance with a preferred embodiment of the present invention.

FIG. 14 illustrates an alternative perspective view of the mold structure of FIG. 13.

FIG. 15 provides a front elevation view of the mold structure of FIG. 13 annotated dimensions G and H for reference.

FIG. 16 shows a side elevation view of the mold structure of FIG. 13 highlighting the thickness I and profile of the mold.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Applicant pioneered Composite Based Additive Manufacturing (CBAM). Applicant's CBAM innovations include those described and/or claimed in the following United States patents (each of which is hereby incorporated by reference in its entirety): U.S. Pat. Nos. 9,393,770, 9,776,376, 9,827,754, 9,833,949, 10,046,552, 10,252,487, 10,350,877, 10,377,080, 10,377,106, 10,384,437, 10,597,249, 10,751,987, 10,934,120, 10,946,592, 10,967,577, 11,040,490, 11,084,134, 11,173,546, 11,370,166, 11,413,790, 11,413,821, 11,584,080, 11,667,081, 11,673,320, 11,673,336, 11,674,207, 11,679,601, 11,806,931, 11,806,935, 11,904,532, 11,904,536, 11,904,549, 11,969,938, 11,969,954, 11,970,584.

It has been discovered that a mold made in part from the Impossible Objects CBAM process can solve many of the problems with conventional products and systems. First, with the use of carbon fiber and fiberglass substrates (among others), and polymers like high performance PEEK, polymer composite molds can be made which can use higher melting point plastics, which have substantially less flex and exceptional strength and can be used with higher melting point resins. The composite nature and the use of fibers gives much greater strength, and less flexing of the mold compared to using homogeneous plastic. This leads much longer mold life, and molds can be produced for thousands of dollars less and in an hour to a day and produce better quality parts.

The addition of boron nitride powder also improves the quality of the mold; by adding boron nitride powder to the polymer powder used in the CBAM process, the heat conductivity of the powder improves, which reduces the increased temperature of the mold. This is advantageous for molding as it reduces cycle time and thus reduces costs. Use of boron nitride also lubricates the mold, making it easier to remove parts, and gives an improved surface finish due to material hardness and reduces the flex in the mold. The boron nitride powder is mixed with, for example, the PEEK polymer before it is used in the printer and before the sheet or web is powdered. Preferably boron nitrate is hexagonal.

It also appears that boron nitride enhancement produces a mold which compresses and flexes less. This allows for steeper draft angles, which is desirable and not available in other additive methods.

The amount of boron nitride can be varied and composites with 15 wt % of the PEEK replaced with boron nitride were found to possess an average of elastic modulus of 15.6 GPa, a failure stress of 227 MPa, and a thermal conductivity of 0.88 W/m−K. This demonstrates that there can be an increase in mechanical properties when compared to typical carbon fiber/PEEK despite including a lubricious material in the composite, accompanied by an over doubling of thermal conductivity. These numbers are increased from the failure stress of carbon fiber PEEK which is in the range of 180 MPa.

Beyond these methods the tools can be plated using electroplating or electroless plating, or continuous vapor deposition, to make any even harder surface for longer mold life.

Using these methods one can make a conventional injection mold that can make thousands of parts at a cost of a few hundred dollars per mold. These costs are much lower than conventional CNC machining of steel or aluminum and can be produced in a day or two. Higher draft angles are also possible. It is possible that building multiple molds would be cheaper than hard tooling with the added advantage that change could be made at little or no cost.

Another advantage, in addition to speed and time, is that actual performance of the mold can be tested and questions about fill, cycle time parting lines and other typical issues can be understood and corrected in a production steel tool.

Referring now to the drawings, exemplary embodiments of the injection mold fabrication system, method, and composite mold articles are illustrated. The invention provides a novel approach to fabricating injection molds made using composite-based additive manufacturing (CBAM) techniques, which significantly reduce production time and costs while improving mold performance and durability.

### CBAM Injection Mold System

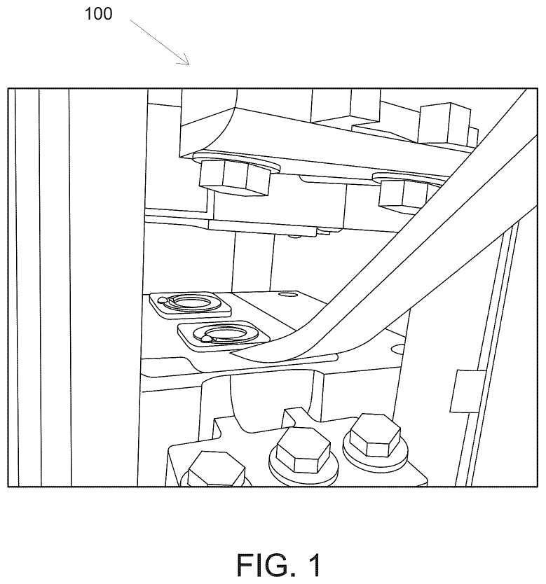

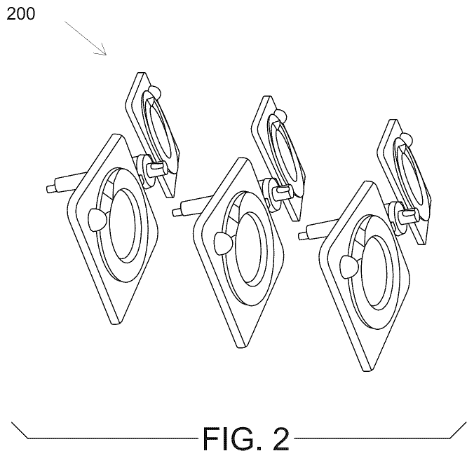

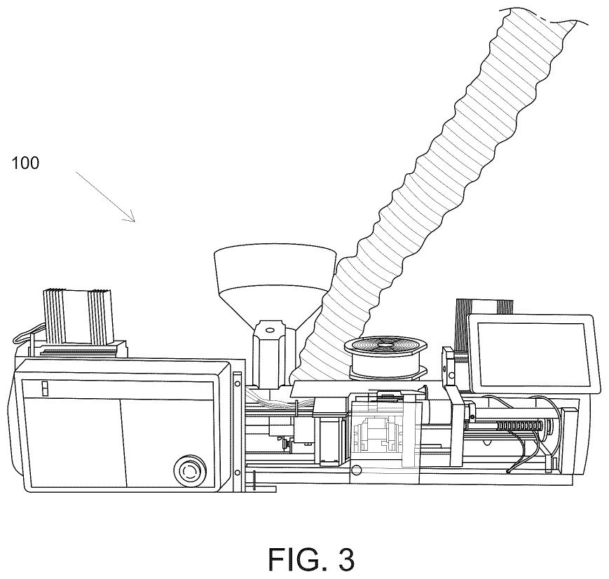

As shown in FIGS. 1-3, the injection mold system 100 includes an additive manufactured mold configured to receive an injection of plastic to be made into a part shaped according to the mold. The mold itself is formed as deposited layers of a composite material to form a mold structure 200, in accordance with CBAM techniques described in the above-mentioned patents (as modified herein). The composite material comprises a high-performance polymer, such as polyether ether ketone (PEEK), and boron nitride powder, which may be hexagonal boron nitride. The boron nitride powder was preferably present during the powdering phase of CBAM manufacturing in an amount ranging from about 10 wt % to about 20 wt % to enhance thermal conductivity and reduce flexing of the mold structure. Reinforcing fibers, such as carbon fiber or fiberglass, were incorporated into the composite material (via their presence on CBAM substrate sheets or webs) to further improve strength and dimensional stability.

### Post-Processing

After the mold structure is fabricated, post-processing may be used to apply a surface finishing treatment. The surface finishing treatment may include electroplating, electroless plating, or continuous vapor deposition, which increases surface hardness, enhances the finish, and extends the mold's operational life. These treatments also enable the mold to produce injection molded parts with steeper draft angles and improved part release. A ceramic based finish (e.g. CERAKOTE®) may also be used.

### Composite Injection Mold

A preferred composite injection mold, as shown by way of example in FIG. 4, comprises a top mold body 401 and bottom mold body 402 which define at least one mold cavity and core configured to shape an injection molded part. The mold body is formed from the composite material described above, which provides enhanced thermal conductivity, reduced flexing, and increased durability. In a preferred embodiment, the mold body further includes a surface finishing coating disposed on its exterior surface to improve surface hardness and finish.

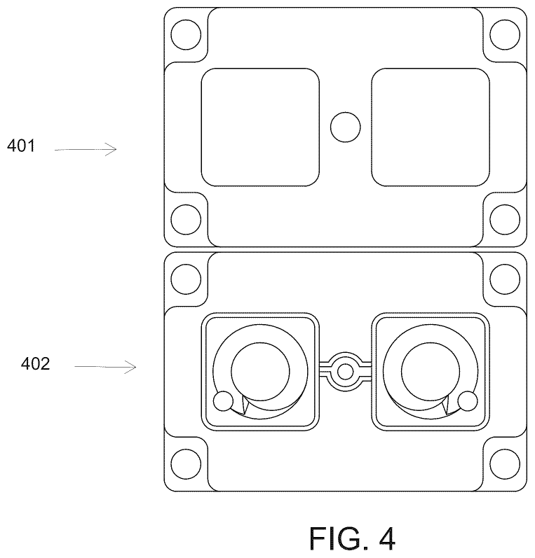

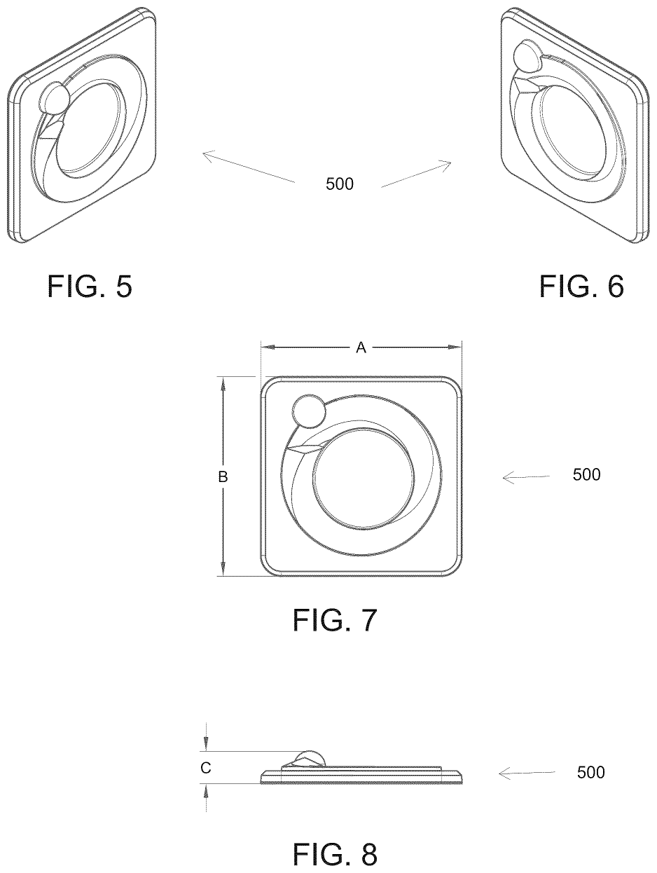

FIGS. 5-8 depict perspective views of a mold structure 500 fabricated using the composite-based additive manufacturing process in accordance with a preferred embodiment of the present invention. FIG. 6 illustrates an alternative perspective view of the mold structure of FIG. 5. FIG. 7 provides a front elevation view of the mold structure of FIG. 5 annotated dimensions A and B for reference, and FIG. 8 shows a side elevation view of the mold structure of FIG. 5 highlighting the thickness C and profile of the mold.

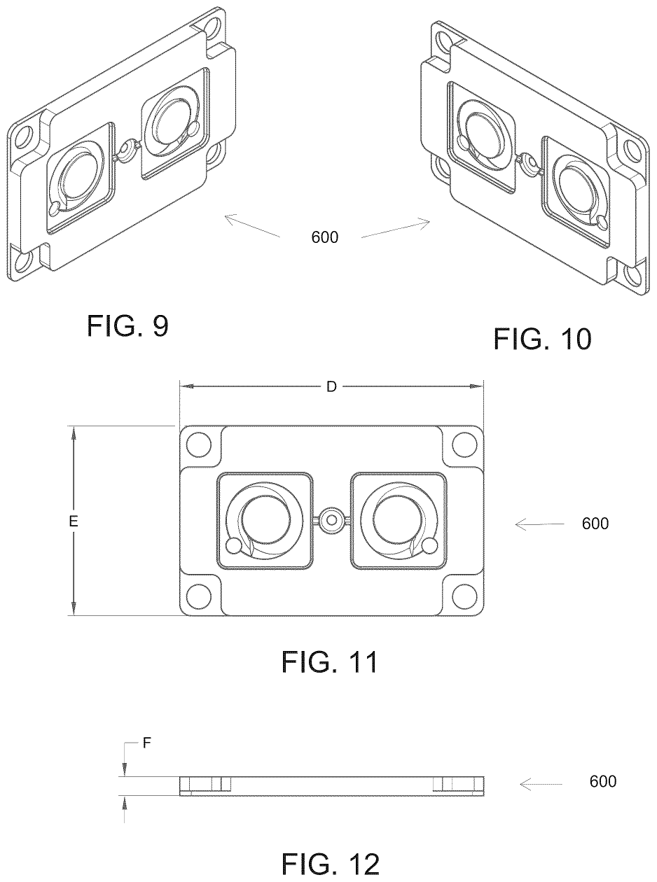

FIGS. 9-12 depict perspective views of a mold structure 600 fabricated using the composite-based additive manufacturing process in accordance with a preferred embodiment of the present invention. FIG. 10 illustrates an alternative perspective view of the mold structure of FIG. 9. FIG. 11 provides a front elevation view of the mold structure of FIG. 9 annotated dimensions D and E for reference, and FIG. 12 shows a side elevation view of the mold structure of FIG. 9 highlighting the thickness F and profile of the mold.

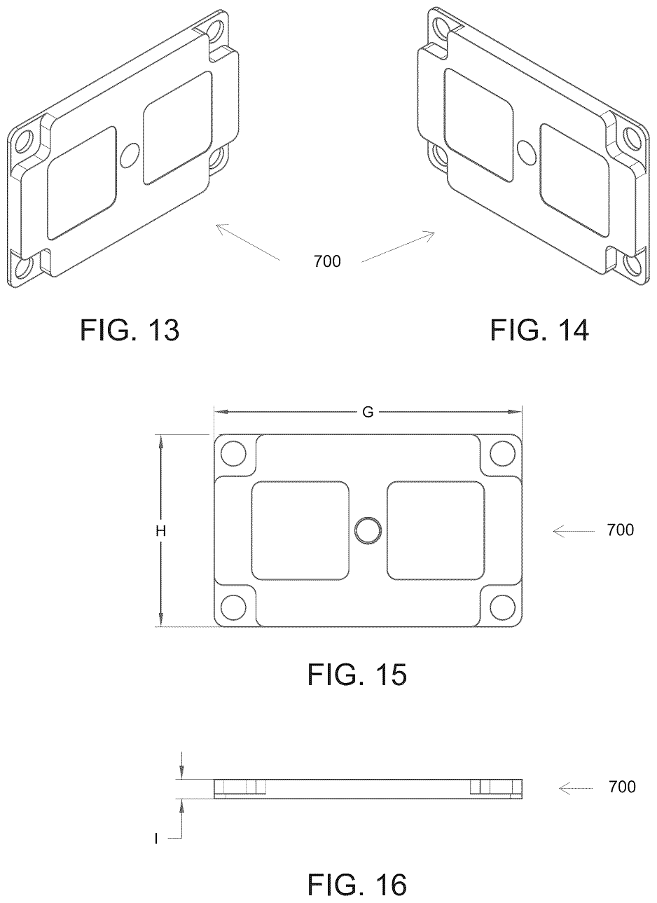

FIGS. 13-16 depict perspective views of a mold structure 700 fabricated using the composite-based additive manufacturing process in accordance with a preferred embodiment of the present invention. FIG. 14 illustrates an alternative perspective view of the mold structure of FIG. 13. FIG. 15 provides a front elevation view of the mold structure of FIG. 13 annotated dimensions G and H for reference, and FIG. 16 shows a side elevation view of the mold structure of FIG. 13 highlighting the thickness I and profile of the mold.

The composite injection molds shown, by way of example in FIGS. 5-16, are adapted for use in an injection molding apparatus of the present invention to produce parts exhibiting improved cycle times, superior surface finish, and reduced mold deformation. The mold's compatibility with higher melting point resins and its ability to maintain dimensional stability under high-pressure conditions make it suitable for a wide range of applications, including automotive components, consumer goods, and rapid prototyping.

The invention addresses longstanding challenges in mold fabrication, including extended lead times, high costs, and unpredictable performance. By utilizing CBAM techniques and incorporating boron nitride powder and reinforcing fibers, the system achieves rapid mold production—often within hours to days—at significantly lower costs compared to conventional CNC machining or other additive manufacturing methods.

Variations of the invention may include adjusting the composition of the composite material to suit specific applications. For example, the amount of boron nitride powder may be varied to optimize thermal conductivity and mechanical properties. Additionally, the reinforcing fibers may be selected based on the desired strength and flexibility of the mold structure.

The invention also supports iterative design testing and short production runs, enabling manufacturers to quickly adapt to changing requirements. Multiple molds can be fabricated at low cost, allowing for design modifications without significant expense or delay.

It should be understood, of course, that the foregoing relates to exemplary embodiments of the invention and that modifications may be made without departing from the spirit and scope of the invention as set forth in the following claims.

What is claimed is:

1. A method of fabricating and using an injection mold, comprising:
blending a polymer with boron nitride powder to form a composite material powder, the boron nitride powder being present in an amount effective to increase thermal conductivity and reduce flexing of the composite material;
printing a cross-sectional layer of an injection mold onto a substrate material comprising fibers, the fibers of the substrate material being selected from the group consisting of carbon fiber and fiberglass or other appropriate substrates;
depositing the composite material powder onto the substrate material so as to cover and adhere to all printed areas of the substrate material;
removing powder that does not adhere to a printed layer;
repeating the printing, depositing and removing steps until all cross-sectional layers of an injection mold have been printed, and stacking layers in registration during the repeating step to make an injection mold build block;
heating the injection mold build block so that the composite powder softens and binds fibers of adjacent layers together in the 3D form of the injection mold;
removing unprinted volumes of the substrate material to reveal the injection mold;
applying a surface finishing treatment to the injection mold to enhance the surface hardness and finish of the mold structure; and
using the injection mold in an injection molding apparatus to produce injection molded parts.

2. The method of claim 1, wherein the polymer is polyether ether ketone (PEEK).

3. The method of claim 1, wherein the boron nitride powder is hexagonal boron nitride.

4. The method of claim 1, wherein the boron nitride powder is present in an amount ranging from about 10 wt % to about 20 wt % based on the weight of the polymer.

5. The method of claim 1, wherein the surface finishing treatment is selected from the group consisting of electroless plating, electroplating and continuous vapor deposition.

6. A composite injection mold, comprising:
a mold body defining at least one mold cavity and core configured to shape an injection molded part;
the mold body being formed from a composite material comprising:
a polymer;
boron nitride powder, present in an amount effective to enhance thermal conductivity and reduce flexing of the composite material; and
reinforcing fibers selected from the group consisting of carbon fiber and fiberglass or other appropriated substrates;
a surface finishing coating disposed on an exterior surface of the mold body, the surface finishing coating configured to increase surface hardness and enhance the surface finish and life; and
wherein the composite injection mold is adapted for use in an injection molding apparatus to produce injection molded parts exhibiting improved cycle times, reduced mold deformation, and increased durability.

7. The composite injection mold of claim 6, wherein the polymer is polyether ether ketone (PEEK).

8. The composite injection mold of claim 6, wherein the boron nitride powder is hexagonal boron nitride.

9. The composite injection mold of claim 6, wherein the boron nitride powder is present in an amount ranging from about 10 wt % to about 20 wt % based on the weight of the polymer.

10. The composite injection mold of claim 6, wherein the surface finishing treatment is selected from the group consisting of electroless plating, electroplating, continuous vapor deposition and ceramic coating.

11. A method of fabricating and using an injection mold, comprising:
printing a cross-sectional layer of an injection mold onto a substrate material comprising fibers, the fibers of the substrate material being selected from the group consisting of carbon fiber and fiberglass or other appropriate substrates;
depositing a polymer powder onto the substrate material so as to cover and adhere to all printed areas of the substrate material;
removing powder that does not adhere to a printed layer;
repeating the printing, depositing and removing steps until all cross-sectional layers of an injection mold have been printed, and stacking layers in registration during the repeating step to make an injection mold build block;
heating the injection mold build block so that the polymer powder softens and binds fibers of adjacent layers together in the 3D form of the injection mold;
removing unprinted volumes of the substrate material to reveal the injection mold;
applying a surface finishing treatment to the injection mold to enhance the surface hardness and finish of the mold structure; and
using the injection mold in an injection molding apparatus to produce injection molded parts.

12. A composite injection mold, comprising:
a mold body defining at least one mold cavity and core configured to shape an injection molded part;
the mold body being formed from a composite material comprising:
a polymer; and
reinforcing fibers selected from the group consisting of carbon fiber and fiberglass or other appropriated substrates;
a surface finishing coating disposed on an exterior surface of the mold body, the surface finishing coating configured to increase surface hardness and enhance the surface finish and life; and
wherein the composite injection mold is adapted for use in an injection molding apparatus to produce injection molded parts exhibiting improved cycle times, reduced mold deformation, and increased durability.
